(19) United States
(12) Patent Application Publication
(10) Pub. No.: US 2025/0357053 A1
(43) Pub. Date: Nov. 20, 2025

(54) CAPACITOR ELEMENT

(71) Applicant: Murata Manufacturing Co., Ltd., Nagaokakyo-shi (JP)

(72) Inventors: Takahisa HIAI, Nagaokakyo-shi (JP); Takaaki Sakai, Nagaokakyo-shi (JP)

(21) Appl. No.: 19/286,359

(22) Filed: Jul. 31, 2025

Related U.S. Application Data
(63) Continuation of application No. PCT/JP2024/025558, filed on Jul. 17, 2024.

(30) Foreign Application Priority Data
Sep. 13, 2023 (JP) 2023-148526

(51) Int. Cl. H01G 9/10; H01G 9/00; H01G 9/048; H01G 9/15

(52) U.S. Cl. CPC H01G 9/10; H01G 9/0003; H01G 9/048; H01G 9/15

(57) ABSTRACT

A capacitor element that includes: a capacitor portion including: an anode plate including a core portion and a porous portion on least one main surface of the core portion, a dielectric layer on a surface of the porous portion, and a cathode layer on a surface of the dielectric layer; a seal layer covering at least one main surface of the capacitor portion. A plurality of through-portions extend through the capacitor portion and the seal layer in a thickness direction. A cover layer with lower moisture permeability than the seal layer 20 is on either one or both of at least a part of a space between an insulating member filled in the through-portions and a wall surface of the anode plate exposed to the through-portions and at least a part of an exposed side surface of the anode plate at an edge of the capacitor portion.

### CROSS REFERENCE TO RELATED APPLICATIONS

The present application is a continuation of International application No. PCT/JP2024/025558, filed Jul. 17, 2024, which claims priority to Japanese Patent Application No. 2023-148526, filed Sep. 13, 2023, the entire contents of each of which are incorporated herein by reference.

### TECHNICAL FIELD

The present disclosure relates to a capacitor element.

### BACKGROUND ART

Patent Document 1 describes a solid electrolyte capacitor. The solid electrolyte capacitor includes an anode plate formed from a valve metal, a porous layer on at least one main surface of the anode plate, a dielectric layer on the surface of the porous layer, an insulating layer filled in the porous layer and on the surface of the porous layer above the portion of the porous layer in which the insulating layer is filled, and a cathode layer including a solid electrolyte layer on the surface of the dielectric layer. The cathode layer is divided into two or more cathode portions. The insulating layer includes a first insulating layer that surrounds at least one of the cathode portions when viewed in a thickness direction. A first through-portion extends through both of the porous layer and the first insulating layer in the thickness direction.
Patent Document 1: International Publication No. 2023/276695

### SUMMARY OF THE DISCLOSURE

Patent Document 1 describes a capacitor that may include a seal layer that covers each one of or either one of both main surfaces of a capacitor layer (hereafter also referred to as a capacitor portion).

However, the seal layer covering the capacitor portion contains resin that has high moisture permeability. Thus, at an exposed portion of the anode plate covered with the seal layer, moisture contained in the capacitor element is more likely to enter, for example, a porous portion of the anode plate. When the capacitor element in that state receives heat, the capacitor element may cause delamination due to expansion of evaporated water, for example, delamination of the cathode layer from the anode plate.

The above is not only an issue of a structure including the cathode layer that is divided into two or more cathode portions, but also a common issue shared by capacitor elements including the capacitor portion that is covered with a seal layer.

The present disclosure is made to address the above issue, and aims to provide a capacitor element capable of preventing delamination caused by water entering an anode plate.

A capacitor element according to the present disclosure includes: a capacitor portion including: an anode plate including a core portion and a porous portion on at least one main surface of the core portion, a dielectric layer on a surface of the porous portion, and a cathode layer on a surface of the dielectric layer; a seal layer covering at least one main surface of the capacitor portion, wherein a plurality of through-portions extend through the capacitor portion and the seal layer in a thickness direction of the capacitor element; and a cover layer with lower moisture permeability than the seal layer on either one or both of (1) at least a part of a space between an insulating member filled in the through-portions and a wall surface of the anode plate exposed to the through-portions and (2) at least a part of an exposed side surface of the anode plate at an edge of the capacitor portion.

The present disclosure can provide a capacitor element capable of preventing delamination caused by water entering an anode plate.

### BRIEF DESCRIPTION OF THE DRAWINGS

FIG. 1 is a schematic cross-sectional view of an example of a capacitor element according to a first embodiment of the present disclosure.

FIG. 2 is a cross-sectional view of the capacitor element illustrated in FIG. 1, taken along line A-A.

FIG. 3A is a schematic cross-sectional view of an example of a capacitor element according to a comparative example including no cover layer. FIG. 3B is a schematic cross-sectional view of an example of a capacitor element according to an embodiment including a cover layer.

FIG. 4 is a schematic cross-sectional view of an example of a capacitor element according to a second embodiment of the present disclosure.

### DESCRIPTION OF THE PREFERRED EMBODIMENTS

A capacitor element according to the present disclosure is described below. The present disclosure is not limited to the structure described below, but may be changed as appropriate within a range not departing from the gist of the present disclosure. In addition, a combination of multiple preferable components described in embodiments below is also included in the present disclosure.

Each embodiment described below is a mere example, and components in different embodiments may be partially replaced with each other or combined with each other. In second and subsequent embodiments, the same points as those in the first embodiment are not described, and only different points are mainly described. Particularly, the same effects in the same structures are not described one by one for each embodiment.

In the description below, a capacitor element is simply referred to as “a capacitor element according to the present disclosure” when the embodiments are not particularly distinguished from one another.

Herein, the terms indicating the relationship between components (for example, “vertical”, “parallel”, or “orthogonal”) and the terms indicating the shape of components do not only indicate the precise meanings, but also include a substantially equivalent range, for example, a difference within about several percents. Herein, “being equivalent” does not only indicate being completely equivalent, but also includes a case of being substantially equivalent, for example, a difference within about several percents.

The drawings described below are schematic diagrams, and may differ from the actual products in terms of, for example, the dimensions or the aspect ratios. In the drawings, the same or equivalent components are denoted with the same reference sign. In each drawing, the same components are denoted with the same reference sign without being described redundantly.

### First Embodiment

A capacitor element according to a first embodiment of the present disclosure includes a single capacitor portion in a seal layer.

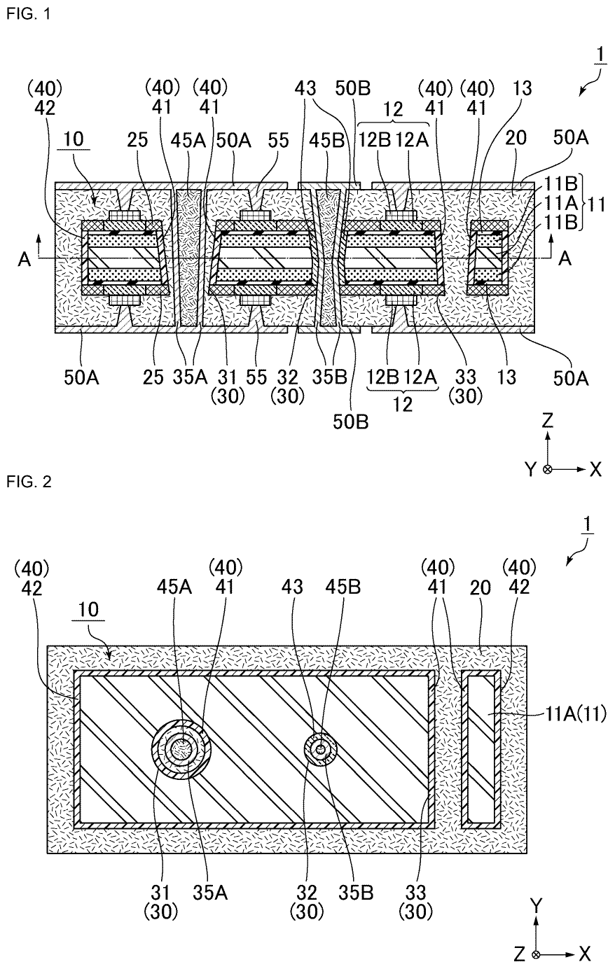

FIG. 1 is a schematic cross-sectional view of an example of a capacitor element according to a first embodiment of the present disclosure. FIG. 2 is a cross-sectional view of the capacitor element illustrated in FIG. 1, taken along line A-A.

A capacitor element 1 illustrated in FIG. 1 includes a capacitor portion 10 and a seal layer 20 disposed to cover at least one of the main surfaces of the capacitor portion 10.

As illustrated in FIG. 1 and FIG. 2, one capacitor portion 10 is disposed inside the seal layer 20.

The capacitor portion 10 includes an anode plate 11 including a core portion 11A and a porous portion 11B on at least one main surface of the core portion 11A, a dielectric layer 13 on the surface of the porous portion 11B, and a cathode layer 12 on the surface of the dielectric layer 13. Thus, the capacitor portion 10 constitutes an electrolytic capacitor. In the example illustrated in FIG. 1, the anode plate 11 includes the porous portion 11B on each of both main surfaces of the core portion 11A, but may include the porous portion 11B simply on either one of the main surfaces of the core portion 11A.

The cathode layer 12 includes, for example, a solid electrolyte layer 12A on the surface of the dielectric layer 13. Preferably, the cathode layer 12 further includes, a conductor layer 12B on the surface of the solid electrolyte layer 12A. When the cathode layer 12 includes the solid electrolyte layer 12A, the capacitor portion 10 constitutes a solid electrolytic capacitor.

The seal layer 20 may include simply one layer or two or more layers. When the seal layer 20 includes two or more layers, the layers may be formed from the same material or different materials.

As illustrated in FIG. 1, the seal layer 20 is preferably on each of both main surfaces of the capacitor portion 10 opposite to each other in the thickness direction (the Z direction in FIG. 1). The seal layer 20 protects the capacitor portion 10.

The seal layer 20 is formed to seal the capacitor portion 10 by, for example, a method of thermocompression bonding an insulating resin sheet, or applying insulating resin paste and then thermosetting the insulating resin paste.

The capacitor element 1 includes multiple through-portions 30 that extend through the capacitor portion 10 and the seal layer 20 in the thickness direction.

The through-portions 30 may include, for example, a first through-hole 31 in which a cathode-through conductor 35A electrically connected to the cathode layer 12 is disposed, a second through-hole 32 in which an anode-through conductor 35B electrically connected to the anode plate 11 is disposed, and/or a through-groove 33 that divides the anode plate 11. The through-portions 30 may include any one or two of the first through-hole 31, the second through-hole 32, and the through-groove 33. The through-portions 30 may include any number of the first through-holes 31, the second through-hole 32, and the through-grooves 33. Although not illustrated, the through-portions 30 may include, for example, a through-hole in which a through-conductor electrically connected to neither the anode plate 11 nor the cathode layer 12 is disposed.

Preferably, an insulating member such as the seal layer 20 is filled in a space between the cathode-through conductor 35A and the wall surface of the anode plate 11 exposed to the first through-hole 31. In the example illustrated in FIG. 1, the seal layer 20 enters the space between the cathode-through conductor 35A and the wall surface of the anode plate 11 exposed to the first through-hole 31.

Preferably, no insulating member such as the seal layer 20 is filled in a space between the anode-through conductor 35B and the wall surface of the anode plate 11 exposed to the second through-hole 32.

Preferably, an insulating member such as the seal layer 20 is filled in the through-groove 33. In the example illustrated in FIG. 1, the seal layer 20 enters the through-groove 33.

As illustrated in FIG. 1, an insulating mask layer 25 may be on at least one of the main surfaces of the anode plate 11 around each through-portion 30.

When the insulating mask layer 25 is disposed around the first through-hole 31, preferably, the insulating mask layer 25 is disposed between the cathode layer 12 and an insulating member (the seal layer 20 in FIG. 1) filled in a space between the cathode-through conductor 35A and the capacitor portion 10.

When the insulating mask layer 25 is disposed around the second through-hole 32, preferably, the insulating mask layer 25 is disposed between the anode-through conductor 35B and the cathode layer 12.

As illustrated in FIG. 1, the insulating mask layer 25 may also be on at least one of the main surfaces of the anode plate 11 to surround the cathode layer 12. Surrounding the cathode layer 12 with the insulating mask layer 25 retains the insulating properties between the anode plate 11 and the cathode layer 12 and reduces a short circuit between the anode plate 11 and the cathode layer 12. The insulating mask layer 25 may be disposed to surround a part of the cathode layer 12, or may be disposed to surround the entire periphery of the cathode layer 12.

In the capacitor element 1, a cover layer 40 with lower moisture permeability than the seal layer 20 is on either one or both of at least a part of the space between the insulating member (the seal layer 20 in the through-portions 30 in FIG. 1) filled in each through-portion 30 and the wall surface of the anode plate 11 exposed to the through-portion 30 and at least a part of the exposed side surface of the anode plate 11 at the edge of the capacitor portion 10.

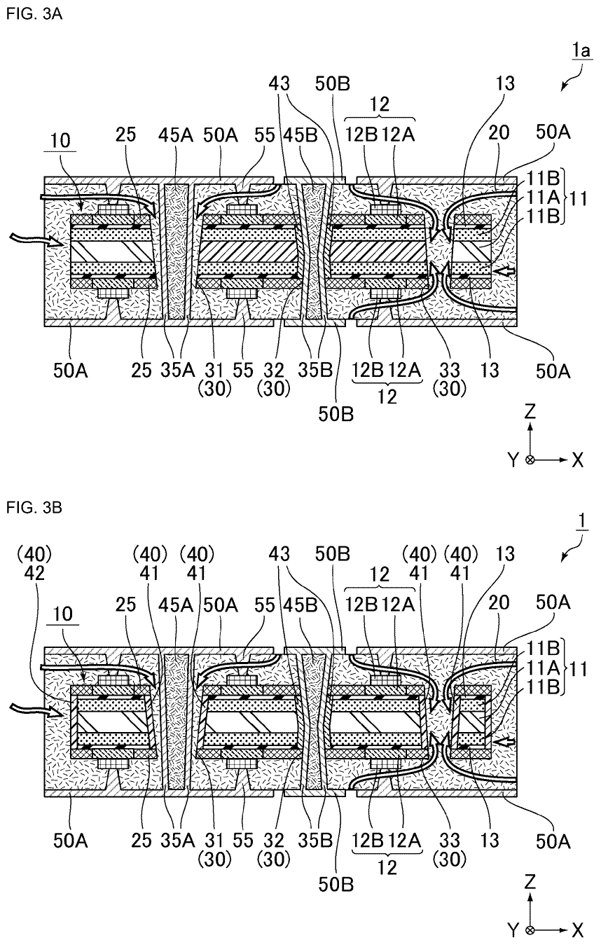

FIG. 3A is a schematic cross-sectional view of an example of a capacitor element according to a comparative example including no cover layer. FIG. 3B is a schematic cross-sectional view of an example of a capacitor element according to an embodiment including a cover layer.

In FIG. 3A and FIG. 3B, examples of water entrance paths are schematically indicated with arrows. The water entrance paths illustrated in FIG. 3A and FIG. 3B are mere examples, and not limited to the paths indicated by the arrows. As illustrated in FIG. 3A and FIG. 3B, although water permeates inward through the seal layer 20, for example, the insulating mask layers 25 disposed on the upper and lower surfaces of the anode plate 11 block water from permeating.

In a capacitor element 1a according to a comparative example illustrated in FIG. 3A, water is more likely to enter the exposed portion of the anode plate 11 through, for example, portions indicated by arrows. In contrast, in the capacitor element 1 according to an embodiment illustrated in FIG. 3B, the cover layers 40 on the exposed portions of the anode plate 11 can block water entering the anode plate 11 through, for example, the portions indicated by arrows. This structure can thus prevent delamination caused by water entering the anode plate 11.

In the capacitor element 1 according to the embodiment illustrated in FIG. 3B, the cover layers 40 on the exposed portions of the anode plate 11 block water entering the anode plate 11, and can thus prevent deterioration of electric characteristics attributable to water.

The cover layers 40 may include simply a cover layer 41 on at least a part of a portion between an insulating member such as the seal layer 20 filled in each through-portion 30 and the wall surface of the anode plate 11 exposed to the through-portion 30, simply a cover layer 42 on at least a part of the exposed side surface of the anode plate 11 at the edge of the capacitor portion 10, or both the cover layer 41 and the cover layer 42.

When the cover layer 41 is disposed between an insulating member such as the seal layer 20 filled in each through-portion 30 and the wall surface of the anode plate 11 exposed to the through-portion 30, the cover layer 41 may be disposed over the entirety between the insulating member filled in the through-portion 30 and the wall surface of the anode plate 11 exposed to the through-portion 30, or at a part of a portion between the insulating member filled in the through-portion 30 and the wall surface of the anode plate 11 exposed to the through-portion 30. Alternatively, the anode plate 11 may have a wall surface where no cover layer 41 is disposed.

When the through-portions 30 include the first through-hole 31, preferably, the cover layer 41 is on at least a part of the wall surface of the anode plate 11 exposed to the first through-hole 31. In this case, preferably, an insulating member such as the seal layer 20 is filled in a space between the cover layer 41 and the cathode-through conductor 35A.

When the through-portions 30 include the through-groove 33, preferably, the cover layer 41 is on at least a part of the wall surface of the anode plate 11 exposed to the through-groove 33. In this case, preferably, an insulating member such as the seal layer 20 is filled in the through-groove 33.

When the cover layer 42 is on the exposed side surface of the anode plate 11 at the edge of the capacitor portion 10, the cover layer 42 may be disposed over the entirety of the exposed side surface of the anode plate 11 at the edge of the capacitor portion 10, or at a part of the exposed side surface of the anode plate 11 at the edge of the capacitor portion 10. Alternatively, the anode plate 11 may have a side surface where no cover layer 42 is disposed.

As illustrated in FIG. 1, preferably, the edge of the capacitor portion 10 is covered with the seal layer 20. In this case, preferably, the cover layer 42 is on at least a part of a portion between the seal layer 20 covering the edge of the capacitor portion 10 and the side surface of the anode plate 11. More specifically, preferably, the cover layer 42 on at least a part of the side surface of the anode plate 11 is covered with the seal layer 20.

The edge of the capacitor portion 10 may be left without being covered with the seal layer 20. More specifically, the cover layer 42 on at least a part of the side surface of the anode plate 11 may be left exposed.

The cover layer 40 may include only a single layer or two or more layers. When the cover layer 40 includes two or more layers, the layers may be formed from the same material or different materials. Alternatively, the cover layers 40 may vary in number of layers included.

To prevent water entering the anode plate 11, preferably, the cover layer 40 has lower moisture permeability than the insulating mask layer 25 on the porous portion 11B. Particularly, the cover layer 40 preferably has gaps smaller than water molecules.

Herein, moisture permeability indicates the water vapor transmission rate measured in conformity with JIS K7129-C (ISO 15106-4).

Examples of the cover layer 40 include a metal layer, a glass layer, and a ceramic layer. Among these, preferably, the cover layer 40 is a metal layer. When the cover layer 40 is a metal layer, the cover layer 40 has lower moisture permeability than the seal layer 20. This structure can thus block water entering the anode plate 11 including the porous portion 11B.

For example, preferably, the anode plate 11 is formed from aluminum or an aluminum alloy, and the cover layer 40 includes a metal layer containing nickel as a main component. Here, the term “main component” refers to the element with the largest weight ratio.

For example, when electroless nickel plating is performed after zincate processing is performed on the wall surface and/or the side surface of the anode plate 11 formed from aluminum or an aluminum alloy, the cover layer 40 including a metal layer containing nickel as a main component can be formed. The cover layer 40 may include a metal layer containing zinc as a main component and a metal layer containing nickel as a main component in order from the anode plate 11.

The dimension of the cover layer 40 in the thickness direction of the anode plate 11 (the Z direction in FIG. 1) may be equivalent to the dimension of the anode plate 11 in the thickness direction, smaller than the dimension of the anode plate 11 in the thickness direction, or greater than the dimension of the anode plate 11 in the thickness direction.

In the example in FIG. 1, the insulating member filled in the through-portions 30 is the seal layer 20 entering the through-portions 30, but may be an insulating member other than the seal layer 20.

The plan figure of the first through-hole 31 (for example, a cross-sectional shape taken perpendicular to the thickness direction of the anode plate 11) is not particularly limited, and may be, for example, circular. Similarly, the plan figure of the second through-hole 32 is not particularly limited, and may be, for example, circular.

When viewed in plan in the thickness direction of the anode plate 11, preferably, the first through-hole 31 is located in the cathode layer 12. Similarly, when viewed in plan in the thickness direction of the anode plate 11, preferably, the second through-hole 32 is located in the cathode layer 12.

The number of the first through-holes 31 may be the same as the number of the second through-holes 32, smaller than the number of the second through-holes 32, or greater than the number of the second through-holes 32.

The diameter of the first through-hole 31 may be equivalent to the diameter of the second through-hole 32, smaller than the diameter of the second through-hole 32, or greater than the diameter of the second through-hole 32.

Herein, the diameter of a through-hole indicates a diameter when the plan figure is a circle, and an equivalent circular diameter when the plan figure is other than a circle.

The diameter of the first through-hole 31 may be uniform in the thickness direction or may vary in the thickness direction. Similarly, the diameter of the second through-hole 32 may be uniform in the thickness direction or may vary in the thickness direction.

The direction in which the through-groove 33 extends is not particularly limited. For example, in FIG. 1 and FIG. 2, the through-groove 33 may extend in the X direction, in the Y direction, or a direction crossing the X direction or the Y direction. The number of the through-grooves 33 is not particularly limited, and may be one or two or more. The through-groove 33 may extend rectilinearly, may be curved, or may be bent.

The width of the through-groove 33 may be uniform in the thickness direction or may vary in the thickness direction. The through-groove 33 may be disposed to cross the anode plate 11 or not to cross the anode plate 11.

The cathode-through conductor 35A is electrically connected to the cathode layer 12.

When viewed in the thickness direction of the anode plate 11, the cathode-through conductor 35A is preferably disposed throughout the entire periphery of the through-hole as illustrated in FIG. 2.

On the inner side of the cathode-through conductor 35A, a first resin-filled portion 45A formed by filling the space defined by the cathode-through conductor 35A with a resin material may be disposed. In this case, the first resin-filled portion 45A is disposed in the space defined by the cathode-through conductor 35A in the first through-hole 31. The first resin-filled portion 45A formed to fill the space in the first through-hole 31 prevents occurrence of delamination of the cathode-through conductor 35A. The first resin-filled portion 45A may be a conductor or an insulator.

The anode-through conductor 35B is electrically connected to the anode plate 11.

As illustrated in FIG. 1, preferably, the anode-through conductor 35B is electrically connected to the wall surface of the anode plate 11 exposed to the second through-hole 32. In other words, preferably, the anode-through conductor 35B is electrically connected to the anode plate 11 at the inner wall surface of the second through-hole 32.

As illustrated in FIG. 2, the anode-through conductor 35B is preferably disposed throughout the entire periphery of the through-hole when viewed in the thickness direction of the anode plate 11. The material from which the anode-through conductor 35B is formed may be the same as or different from the material from which the cathode-through conductor 35A is formed.

The anode-through conductor 35B may be electrically connected to the wall surface of the anode plate 11 with an anode connection layer 43 interposed therebetween. In this case, the anode connection layer 43 functions as a barrier layer to protect the anode plate 11, or more specifically, as a barrier layer to protect the core portion 11A and the porous portion 11B. When the anode connection layer 43 functions as a barrier layer to protect the anode plate 11, dissolution of the anode plate 11 occurring during a chemical solution treatment performed to form a wire layer described later is reduced, and intrusion of the chemical solution into the capacitor portion 10 is reduced. Thus, the reliability is more likely to be improved.

Preferably, the anode connection layer 43 includes a metal layer containing nickel as a main component. In this case, damages on, for example, metal (for example, aluminum) forming the anode plate 11 are reduced, and thus the barrier property of the anode connection layer 43 to protect the anode plate 11 is more likely to be improved.

For example, when electroless nickel plating is performed after zincate processing is performed on the wall surface of the anode plate 11 formed from aluminum or an aluminum alloy, the anode connection layer 43 including a metal layer containing nickel as a main component can be formed. The anode connection layer 43 may include a metal layer containing zinc as a main component and a metal layer containing nickel as a main component laminated in order from the anode plate 11.

The dimension of the anode connection layer 43 in the thickness direction of the anode plate 11 (the Z direction in FIG. 1) may be equivalent to the dimension of the anode plate 11 in the thickness direction, smaller than the dimension of the anode plate 11 in the thickness direction, or greater than dimension of the anode plate 11 in the thickness direction.

The anode-through conductor 35B may be directly connected to the wall surface of the anode plate 11 without using the anode connection layer 43 interposed therebetween.

On the inner side of the anode-through conductor 35B, a second resin-filled portion 45B formed by filling the space defined by the anode-through conductor 35B with a resin material may be disposed. In this case, the second resin-filled portion 45B is disposed in the space defined by the anode-through conductor 35B in the second through-hole 32. The second resin-filled portion 45B formed to fill the space in the second through-hole 32 prevents occurrence of delamination of the anode-through conductor 35B. The second resin-filled portion 45B may be a conductor or an insulator.

In the example illustrated in FIG. 1, first wire layers 50A and second wire layers 50B are on the surfaces of the seal layer 20. In FIG. 1, the first wire layers 50A and the second wire layers 50B are disposed on both the top and the bottom of the capacitor element 1, but may be disposed on either one of the top and the bottom.

The first wire layers 50A are electrically connected to the cathode-through conductor 35A. In the example illustrated in FIG. 1, the first wire layers 50A are electrically connected to the cathode layer 12 through via conductors 55 that extend through the seal layer 20.

The second wire layers 50B are electrically connected to the anode-through conductor 35B. In the example illustrated in FIG. 1, the second wire layers 50B are electrically connected to the anode plate 11 through the anode-through conductor 35B.

### Second Embodiment

A capacitor element according to a second embodiment of the present disclosure includes multiple capacitor portions inside the seal layer.

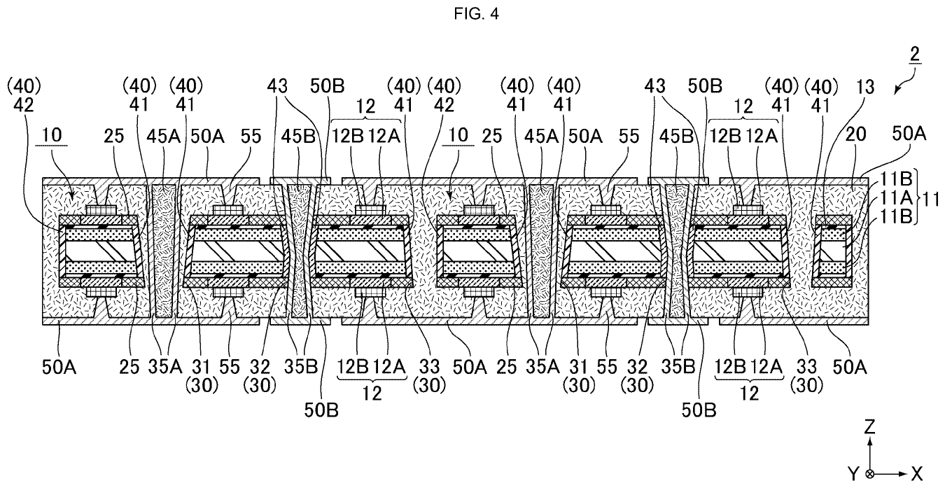

FIG. 4 is a schematic cross-sectional view of an example of a capacitor element according to a second embodiment of the present disclosure.

A capacitor element 2 illustrated in FIG. 4 includes capacitor portions 10 and the seal layer 20 disposed to cover at least one of main surfaces of the capacitor portions 10.

As illustrated in FIG. 4, multiple capacitor portions 10 are disposed inside the seal layer 20. In the example illustrated in FIG. 4, two capacitor portions 10 are disposed inside the seal layer 20.

Preferably, the capacitor portions 10 adjacent to each other are separated by each through-groove 33. In that case, an insulating member such as the seal layer 20 is preferably filled in the through-groove 33.

When the capacitor portions 10 adjacent to each other are separated by each through-groove 33, the capacitor portions 10 adjacent to each other may be physically separated by the through-groove 33. Thus, the capacitor portions 10 adjacent to each other may be electrically separated from each other or electrically connected to each other.

When multiple capacitor portions 10 are disposed inside the seal layer 20, the multiple capacitor portions 10 may be arranged in a plane direction (that is, a plane direction parallel to the X axis and the Y axis) orthogonal to the thickness direction (the Z direction in FIG. 4), disposed to be laminated in the thickness direction, or may be arranged by combining these methods. The multiple capacitor portions 10 may be arranged regularly or irregularly. The capacitor portions 10 may have, for example, the same size and the same shape, or may be partially or entirely different in size and shape. Although the capacitor portions 10 preferably have the same structure, at least one of the capacitor portions 10 may have a different structure.

The number of the capacitor portions 10 may be any number that is two or greater. The capacitor portions 10 may have, for example, the same size and the same shape, or may be partially or entirely different in size and shape.

Although the capacitor portions 10 preferably have the same structure, at least one of the capacitor portions 10 may have a different structure.

Other components are the same as those in the first embodiment.

The capacitor elements 1 and 2 are described below in detail.

Examples of a plan figure of the capacitor portion 10 when viewed in the thickness direction include polygons including a rectangle (a square or a rectangle), a quadrilateral other than a rectangle, a triangle, a pentagon, and a hexagon, a circle, an ellipse, and shapes of a combination of any two or more of these. The plan figure of the capacitor portion 10 may be, for example, an L shape, a C shape (an angular C shape), or a step shape.

Preferably, the anode plate 11 is formed from a valve metal that has a so-called valve function. A valve metal is, for example, a single metal such as aluminum, tantalum, niobium, titanium, or zirconium, or an alloy containing at least one of these metals. Among these, aluminum or an aluminum alloy is preferable.

The anode plate 11 preferably has a flat plate shape, or more preferably has a foil shape. Herein, “a flat plate shape” includes “a foil shape”.

The anode plate 11 may include the porous portion 11B on least one of the main surfaces of the core portion 11A. More specifically, the anode plate 11 may include the porous portion 11B at only one of the main surfaces of the core portion 11A, or may include the porous portions 11B on both main surfaces of the core portion 11A. The porous portion 11B is preferably a porous layer on the surface of the core portion 11A, or is more preferably an etching layer.

Preferably, the thickness of the anode plate 11 before undergoing an etching process is greater than or equal to 60 μm and less than or equal to 200 μm. Preferably, the thickness of the core portion 11A left unetched after the etching process is greater than or equal to 15 μm, and less than or equal to 70 μm. The thickness of the porous portion 11B is designed in accordance with a required withstanding voltage and a required electrostatic capacity, and preferably, the total thickness of the porous portions 11B on both sides of the core portion 11A is greater than or equal to 10 μm and less than or equal to 180 μm.

Preferably, the pore size in the porous portion 11B is greater than or equal to 10 nm, and less than or equal to 600 nm. The pore size in the porous portion 11B refers to a median diameter D50 measured by a mercury porosimeter. The pore size in the porous portion 11B can be controlled by adjusting, for example, various conditions in etching.

The dielectric layer 13 on the surface of the porous portion 11B is porous by reflecting the state of the surface of the porous portion 11B, and has a surface shape with fine irregularities. Preferably, the dielectric layer 13 is formed from an oxide film of the above valve metal. For example, when aluminum foil is used as the anode plate 11, an anode oxidation treatment (also referred to as a chemical conversion treatment) is performed on the surface of aluminum foil in a solution containing, for example, ammonium adipate to form the dielectric layer 13 from an oxide film.

The thickness of the dielectric layer 13 is designed in accordance with a required withstanding voltage and a required electrostatic capacity, but preferably greater than or equal to 10 nm and less than or equal to 100 nm.

When the cathode layer 12 includes the solid electrolyte layer 12A, a conducting polymer such as polypyrrole, polythiophene, or polyaniline is used as an example of a material forming the solid electrolyte layer 12A. Among these, polythiophene is preferable, and poly(3,4-ethylenedioxythiophene) called PEDOT is particularly preferable. The conducting polymer may contain a dopant such as polystyrene sulfonic acid (PSS). The solid electrolyte layer 12A preferably includes an inner layer that fills pores (recesses) of the dielectric layer 13, and an outer layer that covers the dielectric layer 13.

The thickness of the solid electrolyte layer 12A from the surface of the porous portion 11B is preferably greater than or equal to 2 μm, and less than or equal to 20 μm.

The solid electrolyte layer 12A is formed by a method such as forming a polymer film formed from poly(3,4-ethylenedioxythiophene) on the surface of the dielectric layer 13 using a processing liquid containing a monomer such as 3,4-ethylenedioxythiophene, or applying a polymer dispersion liquid formed from poly(3,4-ethylenedioxythiophene) to the surface of the dielectric layer 13 and drying the liquid.

The solid electrolyte layer 12A can be formed in a predetermined area by applying the above processing liquid or dispersion liquid to the surface of the dielectric layer 13 with a method such as sponge transfer, screen printing, dispenser application, or ink-jet printing.

When each cathode layer 12 includes the conductor layer 12B, the conductor layer 12B includes at least one of an electroconductive resin layer and a metal layer. The conductor layer 12B may be simply formed from an electroconductive resin layer or a metal layer. The conductor layer 12B preferably covers the entire surface of the solid electrolyte layer 12A.

An electroconductive adhesive layer containing at least one of electroconductive fillers selected from the group consisting of a silver filler, a copper filler, a nickel filler, and a carbon filler is used as an example of the electroconductive resin layer.

A metal plating layer or a metal foil layer is used as an example of the metal layer. The metal layer is preferably formed from at least one of metals selected from the group consisting of nickel, copper, silver, and alloys each including any of these metals as a main component. The term “main component” refers to the element with the largest weight ratio.

The conductor layer 12B includes, for example, a carbon layer on the surface of the solid electrolyte layer 12A, and a copper layer on the surface of a carbon layer.

The carbon layer is disposed to electrically and mechanically connect the solid electrolyte layer 12A and the copper layer. The carbon layer can be formed in a predetermined area by applying carbon paste to the surface of the solid electrolyte layer 12A with a method such as sponge transfer, screen printing, dispenser application, or ink-jet printing. The thickness of the carbon layer is preferably greater than or equal to 2 μm and less than or equal to 20 μm.

The copper layer can be formed in a predetermined area by applying copper paste to the surface of the carbon layer with a method such as sponge transfer, screen printing, application with spraying, dispenser application, or ink-jet printing. The thickness of the copper layer is preferably greater than or equal to 2 μm and less than or equal to 20 μm.

The cathode-through conductor 35A is formed by, for example, a method described below. First, the first through-hole 31 extending through the capacitor portion 10 in the thickness direction is formed by processing such as drilling or laser processing. Then, the first through-hole 31 is filled with an insulating member such as the seal layer 20. The portion filled with the insulating member then undergoes, for example, drilling or laser processing to form a through-hole. At this time, the diameter of the through-hole is set smaller than the diameter of the first through-hole 31 filled with the insulating member. Thus, the insulating member is interposed between the inner wall surface of the through-hole formed later and the inner wall surface of the first through-hole 31 in the plane direction. The inner wall surface of the through-hole formed later is then metalized with a metal material containing a low-resistance metal such as copper, gold, or silver to form the cathode-through conductor 35A. To form the cathode-through conductor 35A, metalizing the inner wall surface of the through-hole with, for example, electroless copper plating or electrolytic copper plating facilitates processing. Instead of metalizing the inner wall surface of the through-hole, the cathode-through conductor 35A may be formed by filling the through-hole with, for example, a metal material or a composite material containing metal and resin.

The anode-through conductor 35B is formed by, for example, a method described below. First, the second through-hole 32 extending through the capacitor portion 10 and the seal layer 20 in the thickness direction is formed by processing such as drilling or laser processing. Then, the inner wall surface of the second through-hole 32 is metalized with a metal material containing a low-resistance metal such as copper, gold, or silver to form the anode-through conductor 35B. To form the anode-through conductor 35B, metalizing the inner wall surface of the second through-hole 32 with, for example, electroless copper plating or electrolytic copper plating facilitates processing. Except for the method of metalizing the inner wall surface of the second through-hole 32, the anode-through conductor 35B may be formed by filling the second through-hole 32 with, for example, a metal material or a composite material containing metal and resin.

The seal layer 20 is formed from an insulating member. In this case, the seal layer 20 is preferably formed from an insulating resin.

Epoxy resin or phenol resin is used as an example of an insulating resin included in the seal layer 20.

Preferably, the seal layer 20 further includes a filler.

For example, an inorganic filler such as silica particles or alumina particles is used as a filler contained in the seal layer 20.

A layer such as a stress relaxation layer or a moisture-proof film may be disposed between the capacitor portion 10 and the seal layer 20.

The insulating mask layers 25 are formed from an insulating material. In this case, the insulating mask layers 25 preferably include an insulating resin.

As an example of the insulating resin included in the insulating mask layers 25, polyphenylsulfone resin, polyethersulfone resin, cyanate ester resin, fluorocarbon polymer (tetrafluoroethylene, or perfluoroalkylvinylether-tetrafluoroethylene copolymer), polyimide resin, polyamide-imide resin, epoxy resin, or a derivative or a precursor of any of these is used.

The insulating mask layers 25 may be formed from the same resin as that of the seal layer 20. Unlike the seal layer 20, when the insulating mask layers 25 contain an inorganic filler, the effective capacitance of the capacitor portion 10 may be adversely affected. Thus, the insulating mask layers 25 are preferably formed from a system of resin alone.

The insulating mask layers 25 can be formed in predetermined areas by applying a masking material such as a composite containing an insulating resin to the surface of the porous portion 11B with a method such as sponge transfer, screen printing, dispenser application, or ink-jet printing.

The insulating mask layers 25 may be formed on the porous portion 11B before the dielectric layer 13 is formed or after the dielectric layer 13 is formed.

A metal material containing a low-resistance metal such as silver, gold, or copper is used as an example of a material of the first wire layer 50A. In this case, the first wire layer 50A is formed by a method such as plating the surface of the cathode-through conductor 35A.

To improve the adhesion between the first wire layer 50A and another member, or in this example, the adhesion between the first wire layer 50A and the cathode-through conductor 35A, a mixture of a resin and at least one of electroconductive fillers selected from the group consisting of a silver filler, a copper filler, a nickel filler, and a carbon filler may be used as a material of the first wire layer 50A.

A metal material containing a low-resistance metal such as silver, gold, or copper is used as an example of a material of the second wire layer 50B. In this case, the second wire layer 50B is formed by a method such as plating the surface of the anode-through conductor 35B.

To improve the adhesion between the second wire layer 50B and another member, or in this example, the adhesion between the second wire layer 50B and the anode-through conductor 35B, a mixture of a resin and at least one of electroconductive fillers selected from the group consisting of a silver filler, a copper filler, a nickel filler, and a carbon filler may be used as a material of the second wire layer 50B.

Preferably, the first wire layer 50A and the second wire layer 50B are formed from the same material, or at least the same type of material, but may be formed from different materials.

When multiple capacitor portions 10 are disposed in the seal layer 20, each of the multiple capacitor portions 10 may include the first wire layer 50A electrically connected to the cathode layer 12, and the second wire layer 50B electrically connected to the anode plate 11, or at least one of the first wire layer 50A and the second wire layer 50B may be shared between the multiple capacitor portions 10.

A metal material containing a low-resistance metal such as silver, gold, or copper is used as an example of a material of the inner via conductor 55.

The inner via conductor 55 is formed by a method such as plating the inner wall surface of a through-hole extending through the seal layer 20 in the thickness direction with the above metal material, or filling the through-hole with electroconductive paste and then performing thermal treatment on the electroconductive paste.

A capacitor element according to the present disclosure is not limited to the above embodiments, and may be applied or modified in various manners in relation to, for example, components or manufacturing conditions of the capacitor element within the scope of the present disclosure.

A capacitor element according to the present disclosure is preferably usable as a material of a compound electronic component. Such a compound electronic component includes, for example, a capacitor element according to the present disclosure, an outer electrode on an outer surface of a seal layer of the capacitor element and electrically connected to an anode plate and a cathode layer of the capacitor element, and an electronic component connected to the outer electrode layer.

In the compound electronic component, the electronic component connected to an outer electrode may be a passive element or an active element. Both of the passive element and the active element may be connected to the outer electrode, or either one of the passive element and the active element may be connected to the outer electrode. Alternatively, a composite of the passive element and the active element may be connected to an outer electrode.

Examples of the passive element include an inductor. Examples of the active element include a memory, a graphical processing unit (GPU), a central processing unit (CPU), a microprocessing unit (MPU), and a power management integrated circuit IC (PMIC).

A capacitor element according to the present disclosure has a sheet shape as a whole. Thus, in the compound electronic component, the capacitor element can be treated as a mount board, and electronic components can be mounted on the capacitor element. In addition, when electronic components with a sheet shape are mounted on the capacitor element, the capacitor element and the electronic component can be connected in the thickness direction with a through-hole conductor extending through each electronic component in the thickness direction. Thus, the active element and the passive element can be formed as an integrated module.

For example, when a capacitor element according to the present disclosure is electrically connected between a voltage regulator including a semiconductor active element and a load to which a converted direct-current voltage is supplied, a switching regulator can be formed.

After a circuit layer is formed on one of surfaces of a capacitor matrix sheet in which multiple capacitor elements according to the present disclosure are laid out, the compound electronic component may be connected to the passive element or the active element.

Alternatively, a capacitor element according to the present disclosure may be disposed in a cavity portion formed in a substrate in advance, and embedded in the cavity portion with resin, and then a circuit layer may be formed over the resin. In another cavity portion formed in the substrate, another electronic component (a passive element or an active element) may be disposed.

Alternatively, a capacitor element according to the present disclosure may be mounted on a smooth carrier such as a wafer or glass, an outer layer portion may be formed from resin, a circuit layer may be formed, and the capacitor element may then be connected to the passive element or the active element.

### REFERENCE SIGNS LIST

1, 1a, 2 capacitor element
10 capacitor portion
11 anode plate
11A core portion
11B porous portion
12 cathode layer
12A solid electrolyte layer
12B conductor layer
13 dielectric layer
20 seal layer
25 insulating mask layer
30 through-portion
31 first through-hole
32 second through-hole
33 through-groove
35A cathode-through conductor
35B anode-through conductor
40, 41, 42 cover layer
43 anode connection layer
45A first resin-filled portion
45B second resin-filled portion
50A first wire layer
50B second wire layer
55 via conductor

1. A capacitor element, comprising:
a capacitor portion including:
an anode plate including a core portion and a porous portion on at least one main surface of the core portion,
a dielectric layer on a surface of the porous portion, and
a cathode layer on a surface of the dielectric layer;
a seal layer covering at least one main surface of the capacitor portion, wherein a plurality of through-portions extend through the capacitor portion and the seal layer in a thickness direction of the capacitor element; and
a cover layer with lower moisture permeability than the seal layer on either one or both of (1) at least a part of a space between an insulating member filled in the through-portions and a wall surface of the anode plate exposed to the through-portions and (2) at least a part of an exposed side surface of the anode plate at an edge of the capacitor portion.

2. The capacitor element according to claim 1,
wherein the through-portions include a first through-hole having a cathode-through conductor electrically connected to the cathode layer,
wherein the cover layer is on at least a part of the wall surface of the anode plate exposed to the first through-hole, and
wherein the insulating member is filled in a space between the cover layer and the cathode-through conductor.

3. The capacitor element according to claim 2,
wherein the through-portions include a through-groove that divides the anode plate,
wherein the cover layer is on at least a part of the wall surface of the anode plate exposed to the through-groove, and
wherein the insulating member is filled in the through-groove.

4. The capacitor element according to claim 3,
wherein the edge of the capacitor portion is covered with the seal layer, and
wherein the cover layer is on at least a part of a portion between the seal layer that covers the edge of the capacitor portion and the side surface of the anode plate.

5. The capacitor element according to claim 4,
wherein the through-portions include a second through-hole having an anode-through conductor electrically connected to the anode plate, and
wherein the anode-through conductor is electrically connected to the wall surface of the anode plate exposed to the second through-hole.

6. The capacitor element according to claim 1,
wherein the through-portions include a through-groove that divides the anode plate,
wherein the cover layer is on at least a part of the wall surface of the anode plate exposed to the through-groove, and
wherein the insulating member is filled in the through-groove.

7. The capacitor element according to claim 6,
wherein the edge of the capacitor portion is covered with the seal layer, and
wherein the cover layer is on at least a part of a portion between the seal layer that covers the edge of the capacitor portion and the side surface of the anode plate.

8. The capacitor element according to claim 7,
wherein the through-portions include a second through-hole having an anode-through conductor electrically connected to the anode plate, and
wherein the anode-through conductor is electrically connected to the wall surface of the anode plate exposed to the second through-hole.

9. The capacitor element according to claim 1,
wherein the edge of the capacitor portion is covered with the seal layer, and
wherein the cover layer is on at least a part of a portion between the seal layer that covers the edge of the capacitor portion and the side surface of the anode plate.

10. The capacitor element according to claim 9,
wherein the through-portions include a second through-hole having an anode-through conductor electrically connected to the anode plate, and
wherein the anode-through conductor is electrically connected to the wall surface of the anode plate exposed to the second through-hole.

11. The capacitor element according to claim 1, wherein the cover layer is a metal layer.

12. The capacitor element according to claim 1,
wherein the anode plate comprises aluminum or an aluminum alloy, and
wherein the cover layer includes a metal layer containing nickel as a main component.

13. The capacitor element according to claim 1,
wherein the through-portions include a second through-hole having an anode-through conductor electrically connected to the anode plate, and
wherein the anode-through conductor is electrically connected to the wall surface of the anode plate exposed to the second through-hole.

14. The capacitor element according to claim 1, wherein the capacitor element includes a plurality of the capacitor portions, and the seal layer covers the plurality of the capacitor portions.

15. The capacitor element according to claim 1, wherein the insulating member filled in the through-portions is the seal layer.

16. The capacitor element according to claim 1, wherein the cathode layer includes a solid electrolyte layer on a surface of the dielectric layer.
